(19) United States
(12) Patent Application Publication
(10) Pub. No.: US 2003/0094780 A1
(43) Pub. Date: May 22, 2003

(54) Trailing arm for absorbing lateral and axial forces in a suspension system of a vehicle

(76) Inventor: Young-Gun Cho, Seoul (KR)

Correspondence Address: Pennie & Edmonds, LLP, 3300 Hillview Avenue, Palo Alto, CA, 94304, US

(21) Appl. No.: 10/291,341

(22) Filed: Nov. 7, 2002

(30) Foreign Application Priority Data
Nov. 20, 2001 (KR) 2001-0072309

(51) Int. Cl. B60G 3/12

(52) U.S. Cl. 280/124.128

(57) ABSTRACT

A trailing arm is provided that comprises: a first coupling member connectable with a vehicle body; a second coupling member connectable with a wheel assembly; and a plurality of connecting beams for connecting the first and second coupling members together. Each of the connecting arms are angled with respect to a longitudinal direction of the trailing arm such that the connecting arms cross paths, or cooperatively form an X-shape, as they diagonally connect the first and second coupling members together.

### FIELD OF THE INVENTION

Generally, the present invention relates to a suspension system. More specifically, the present invention relates to a trailing arm for a rear suspension system of a vehicle in which lateral force and axial force can be absorbed.

### BACKGROUND OF THE INVENTION

Generally, a rear suspension system of a vehicle includes a trailing arm for connecting the vehicle body with the rear wheel assembly. Typically, a trailing arm is connected to a knuckle through bolts at one end of the trailing arm. The other end of the trailing arm is generally connected to a vehicle body through a bushing. Generally, a linking member of the trailing arm must endure a great deal of stress, and the rear suspension system is designed such that deformation occurs only in the bushing or spring where the trailing arm attaches to the vehicle body.

However, in some designs, deformation of the suspension system occurs in two directions. That is, the trailing arm can rotate by a force applied in the vertical direction or the trailing arm can flex from a force applied in a direction perpendicular to its longitudinal axis. Therefore, a lateral deformation of the trailing arm occurs simultaneously with deformation of the bushing connecting the trailing arm to the vehicle body. Both deformations have an effect on the suspension characteristics.

For good suspension characteristics, the trailing arm must be sufficiently deflected during vehicle displacement in the vertical direction, yet structurally sufficient to withstand permanent deformation. If the trailing arm is too flexible, force will be transmitted to the bushing in a lateral direction which has a negative result of excessive wear on the bushing.

Furthermore, typical trailing arms cannot absorb axial force generated along the longitudinal direction of the trailing arm such that impacts to the wheel that generate force applied along that direction are transferred to the occupants of the vehicle and create an uncomfortable ride.

### SUMMARY OF THE INVENTION

In a preferred embodiment of the present invention, a trailing arm includes a first coupling member connected to a second connecting member by a plurality of connecting beams. In use, the first coupling member is connectable with a vehicle body, the second coupling member is connectable with a wheel assembly, and the plurality of connecting beams connect the first and second coupling members together.

It is preferable that the plurality of connecting beams comprise a set of first connecting beams and a second connecting beam that are not parallel to each other with respect to the longitudinal axis of the trailing arm. In use, the set of first connecting beams and second connecting beam cooperatively form an X-shape, in a cross sectional view, as they diagonally connect the first and second coupling members together.

It is also preferable that the first coupling member is provided with a hollow portion perforated therethrough.

### BRIEF DESCRIPTION OF THE DRAWINGS

The accompanying drawings, which are incorporated in and constitute a part of the specification, illustrate an embodiment of the invention, and, together with the description, serve to explain the principles of the invention, where:

FIG. 1 schematically shows the trailing arm according to a preferred embodiment of the present invention;

FIG. 2 is a diagram showing the trailing arm of FIG. 1 deformed by a lateral force; and

FIG. 3 is a diagram showing the trailing arm of FIG. 1 deformed by an axial force.

### DETAILED DESCRIPTION OF THE PREFERRED EMBODIMENTS

Hereinafter, a preferred embodiment of the present invention will be described in detail with reference to the accompanying drawings.

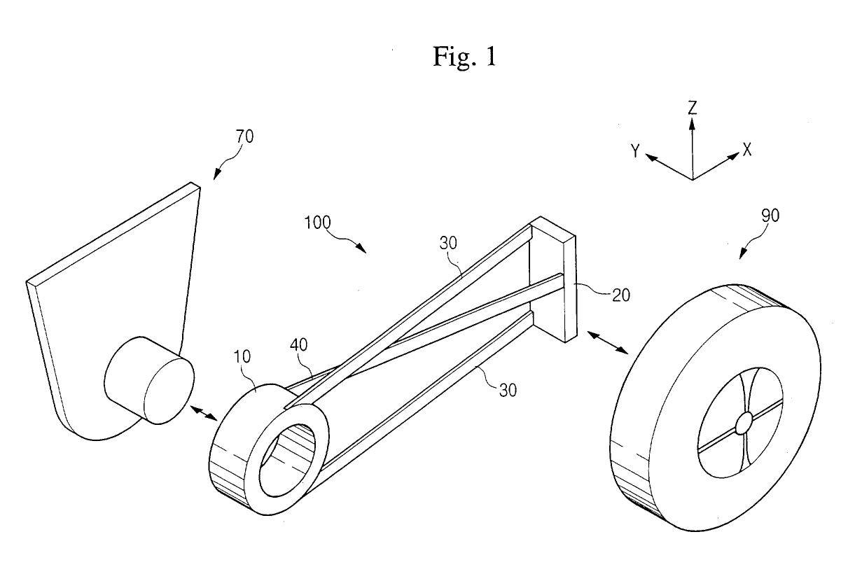

As shown in FIG. 1, a trailing arm 100, for use in a rear suspension system, according to an embodiment of the present invention, includes a first coupling member 10 for coupling it to a vehicle body 70, a second coupling member 20 for coupling it to a wheel assembly 90, a plurality of first connecting beams 30, and a second connecting beam 40.

It is preferable that the first coupling member 10 is provided with a cylindrical hollow portion 12 for the connection to the vehicle body 70, through a coupling device, such as for example a bushing or a bolt (not shown). The second coupling member 20 is provided for coupling the trailing arm 100 to the wheel assembly 90. It is preferable that the second coupling member 20 is coupled to a knuckle (not shown) of the wheel assembly 90 through bolts or the like.

The plurality of first connecting beams 30 are in substantial alignment with each other. However, the plurality of first connecting beams 30 are not parallel to the longitudinal axis of the trailing arm such that the plurality of first connecting beams 30 diagonally interconnect the first coupling member 10 with the second coupling member 20. The longitudinal direction of the trailing arm is substantially similar to the longitudinal axis of the vehicle. The angle of the plurality of first connecting beams 30 can preferably be determined, with respect to the longitudinal axis of the trailing arm, on the basis of the length of the plurality of first connecting beams 30, the thickness of the plurality of the first connecting beams 30, and the size of the wheel to which the second coupling member 20 is to be attached.

The second connecting beam 40 is not parallel to the longitudinal axis of the trailing arm such that the second connecting beam 40 diagonally interconnects the first coupling member 10 with the second coupling member 20. The angle of the second connecting beam 40 can preferably be determined, with respect to the longitudinal axis of the trailing arm, on the basis of the length of the second connecting beam 40, the thickness of the second connecting beam 40, and the size of the wheel to which the second coupling member 20 is to be attached.

The angle of the second connecting beam 40 is directed toward the plurality of first connecting beams 30, and the angle of the plurality of first connecting beams 40 is directed toward the second connecting beam 40 such that the path of the plurality of first connecting beams 30 and the path of the second connecting beam 40 cross somewhere along the path between the first coupling member 10 and the second coupling member 20. Thereby the plurality of first connecting beams 30 and the second connecting beam 40 cooperatively form an “X” shape if viewed in cross section.

In use, under this configuration, the trailing arm 100 can absorb a moment of inertia with respect to the Z-axis (hereinafter referred to as a vertical force), a force in a lateral Y-axis direction, or in other words, a force applied perpendicular to the longitudinal axis of the trailing arm (hereinafter referred to as a lateral force), and a force in a longitudinal X-axis direction, or in other words, a force directed along the longitudinal axis of the trailing arm (hereinafter referred to as an axial force).

It is to be appreciated that although the trailing arm 100 of FIG. 1 is shown with two first connecting beams 30 and one second connecting beam 40, the number of first connecting beams and second connecting beam(s) can preferably be changed according to expected magnitudes of the lateral and the axial forces, and the like.

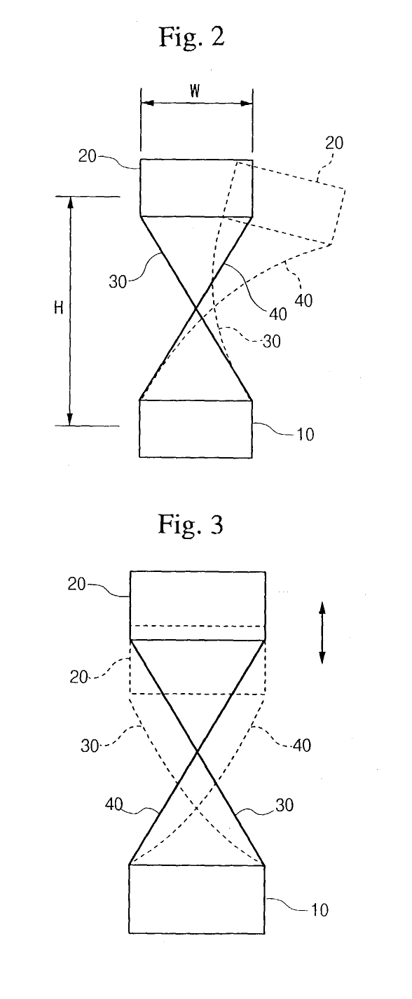

With reference to FIGS. 2 and 3, operations of the trailing arm 100 under the lateral force and the axial force will respectively be explained.

In FIGS. 2 and 3, solid lines shows a state before deformation, and dotted lines show a state after deformation.

As shown in FIG. 2, if a lateral force is applied to the trailing arm 100, the first connecting beams 30 and second connecting beam 40 are flexed in the direction of the lateral force so that the trailing arm 100 is deformed along the Y-axis direction (refer to FIG. 1 for axis directions). In use, during this deformation, the lateral force is substantially absorbed in the first connecting beams 30 and second connecting beam 40 of the trailing arm 100.

As shown in FIG. 3, if an axial force is applied to the trailing arm 100, the first connecting beams 30 and second connecting beam 40 are flexed so that the trailing arm 100 is deformed along the X-axis direction (refer to FIG. 1 for axis directions). In use, during this deformation, the axial force is substantially absorbed in the trailing arm 100. Therefore, axial impacts on the wheel assembly can be substantially absorbed.

Referring now to FIG. 2, a length H of the trailing arm 100 is larger than a width W of the trailing arm 100, and it is preferable that axial integrity of the trailing arm 100 is set to be greater than a lateral integrity of the trailing arm 100 such that both desired suspension characteristics and a desired structural integrity of the trailing arm 100 are satisfied.

Consequently, the trailing arm 100 according to the present invention can be designed to have any desired structural integrity with respect to an impact force originating from any of the X, Y, or Z axis directions.

Although a preferred embodiment of the present invention has been described in detail hereinabove, it should be clearly understood that many variations and/or modifications of the basic inventive concepts herein taught which may appear to those skilled in the present art will still fall within the sprit and scope of the present invention, as defined in the appended claims.

What is claimed is:

1. A trailing arm for a rear suspension system of a vehicle, comprising:
a first coupling member configured for attachment to a vehicle body;
a second coupling member configured for attachment to a wheel assembly; and
a plurality of connecting beams for connecting said first coupling member with said second coupling member.

2. The trailing arm of claim 1, wherein said plurality of connecting beams are not parallel with respect to a longitudinal direction of said trailing arm such that each of the plurality of connecting beams diagonally connect said first coupling member with said second coupling member.

3. The trailing arm of claim 2, wherein said plurality of connecting beams comprise a first connecting beam and a second connecting beam angled toward each other such that said first connecting beam and said second connecting beam cross paths somewhere between said first coupling member and said second coupling member.

4. The trailing arm of claim 1, wherein said first coupling member is configured to couple over a mounting point on a vehicle.

5. A trailing arm for a rear suspension system of a vehicle, comprising:
a first coupling member configured to couple to a vehicle body;
a second coupling member configured to couple to a wheel assembly of a vehicle; and
an elongate force absorption member connecting said first coupling member to said second coupling member, wherein said elongate force absorption member is extended along an axis and configured to absorb an impact force applied to said elongate force absorption member along said axis.

6. The trailing arm for a rear suspension system of a vehicle of claim 5, wherein said elongate force absorption member comprises a plurality of connecting beams configured to deform in axial and lateral directions.

7. The trailing arm for a rear suspension system of a vehicle of claim 6, wherein at least one said connecting beam crosses at least one other connecting beam.

8. The trailing arm for a rear suspension system of a vehicle of claim 6, wherein said elongate force absorption member is configured such that said lateral deformation is in response to a force applied perpendicular to said axis of said elongate force absorption member such that said perpendicular force is absorbed in said lateral deformation of said connecting beams.

9. The trailing arm for a rear suspension system of a vehicle of claim 6, wherein said elongate force absorption member is configured such that said axial deformation is in response to an axial force applied to said elongate force absorption member such that said axial force is absorbed in said axial deformation of said connecting beams.
